(19) United States
(12) Patent Application Publication
(10) Pub. No.: US 2004/0111970 A1
(43) Pub. Date: Jun. 17, 2004

(54) Window lift mechanism

(76) Inventor: Paul J. Fenelon, Nashville, TN (US)

Correspondence Address: HARNESS, DICKEY & PIERCE, P.L.C., P.O. BOX 828, BLOOMFIELD HILLS, MI, 48303, US

(21) Appl. No.: 10/731,243

(22) Filed: Dec. 9, 2003

Related U.S. Application Data
(63) Continuation-in-part of application No. 10/124,943, filed on Apr. 18, 2002.
(63) Continuation-in-part of application No. 10/400,820, filed on Mar. 27, 2003.

(51) Int. Cl. E05F 15/08

(52) U.S. Cl. 49/349

(57) ABSTRACT

A dual rack and pinion system is provided for a window lift mechanism. The window lift mechanism includes improved window brackets for simple mounting to a window. A modular frame design is provided to improve assembly of the window lift mechanism into the door of a vehicle. An improved assembly method is provided for the dual rack and pinion system. The system is also provided with a smart motor and incorporates resilient shock absorbers in the dual rack and pinion gear train to allow more time for the smart motor to detect and react to an obstruction in the window. The window lift mechanism includes a support bracket mounted to the window and a motor supported on a support bracket, wherein the support bracket permits axial and rotational movement of the window relative to the support bracket.

### CROSS-REFERENCE TO RELATED APPLICATIONS

This application is a continuation-in-part of U.S. patent application Ser. No. 10/124,943 filed on Apr. 18, 2002 and U.S. patent application Ser. No. 10/400,820 filed Mar. 27, 2003. The disclosures of the above applications are incorporated herein by reference.

### FIELD OF THE INVENTION

The present invention relates generally to an apparatus for moving a window into an open or closed position. In particular, the present invention relates to a mechanism for use with an automobile window, wherein the mechanism utilizes an improved dual rack and pinion assembly and method of manufacturing. The mechanism further utilizes pinion gears with resilient shock absorbers to cushion the system from disturbances, a clutch mechanism to prevent back-drive of the worm gear and a support bracket that allows the window to find the path of least resistance during closure.

### BACKGROUND OF THE INVENTION

Modern automobiles typically include a window lift assembly for raising and lowering windows in the door of the vehicle. A common type of window lift assembly incorporates a “scissor mechanism” or a drum and cable mechanism. A scissor-type system utilizes a series of linkages in a scissor configuration such that as the bottom linkages move apart, the top linkages do as well, resulting in a scissor-like motion. The window is fastened to a bracket connected to a linkage. A motor and gearset drives the scissor mechanism in power operated window mechanisms.

The scissor-type and drum and cable mechanisms are typically mechanically inefficient, prohibiting the use of light-weight materials and requiring the use of relatively large motors to drive the system. The large motors necessarily require increased space and electrical power and also increase the weight of the system. With the limited space in a scissor-type or drum and cable system it is also necessary, in order to provide the required torque transfer efficiency and acceptable up and down times (3-4 seconds), to have a small diameter pinion gear, typically 0.5 to 0.75 inches, and relatively large worm gear, typically 1.8 to 2.5 inches in diameter, with gear ratios of 9 to 16 and 80 to 90, respectively. This results in excessive worm gear speed in the range of 3000 to 4000 RPM which causes excessive worm gear tooth shock and armature noise. The combination of high torque, typically 80 to 125 inch-pounds at stall, and shock due to high worm speeds mandates that either expensive multiple gears and/or single worm gears with integral shock absorbers be utilized.

Further, the scissor-type mechanism does not take into account the manufacturing deviations in the door, specifically with the window frame and mounting points, and deviations in the manufacture of the scissor-type mechanism. Deviations in the door and scissor-type mechanism result in larger than necessary forces being applied to the window when it cycles up and down. The larger force on the window causes undesirable noise in the passenger cabin.

Accordingly, a need exists for a window lift mechanism with increased efficiency that would allow for a reduction in the motor size and hence the mass of the system, and a support structure for the window that permits the window to find the path of least resistance when it cycles up and down.

### SUMMARY OF THE INVENTION

The present invention provides a window lift mechanism that utilizes a dual rack and pinion drive mechanism that includes a motorized input from a worm shaft that drives a worm gear drivingly connected to one of the pinions of the dual rack and pinion system. A motor with the worm driveshaft and the pinions are supported by a base which traverses the dual rack structure when the dual pinions are driven. According to one aspect of the present invention, the window lift mechanism has two support structures each including a window bracket coupled to the window. The window brackets each include a channel for receiving the window therein. A pair of metal plates are disposed on opposite sides of the window bracket and include a clamping mechanism engaging each of the pair of metal plates for drawing the metal plates toward one another.

There is an interface between the first and second supports which permits axial and rotational movement of the window with respect to the second support. Specifically, the first support has a forked side coupled to the window and a slot for receipt of a protrusion from the second support. The allowed movement of the window allows the closure member to find the path of least resistance during closure, and aids in overcoming manufacturing imperfections.

According to an alternative embodiment of the present invention, the window brackets are each provided with a wedge mechanism received in the channel for securing the closure member in the channel.

According to another aspect of the present invention, a method for assembling a window lift mechanism is provided including mounting a motor to a base, the motor including a worm drive shaft and worm gear meshingly engaged therewith. The method includes loading pinion gears into the base by placing the pinion gear onto a drive shaft connected to the worm gear and mounting the second pinion gear in the base. A dual rack assembly is then placed in alignment with the pinion gears and power is applied to the motor to drive the pinion gears to engage the pinion gears with the rack.

According to still another aspect of the present invention, the dual rack assembly is made as a modular unit including a base or frame structure which is adapted to be mounted to the door of the vehicle. The pair of rack members each including a plurality of gear teeth extending along the rack members are formed either as a molded unitary piece with the base structure, or are snap fit or otherwise fastened to the base structure for defining the modular unit.

According to yet another aspect of the present invention, the dual rack and pinion assembly is provided with a smart motor capable of detecting unusual forces applied to the window while being closed and capable of either shutting off or reversing drive of the motor. The system is further provided with one or more resilient shock absorbers operably engaged between the worm gear and pinion gears in order to allow the drive motor to have more time to react to unusual forces applied to the window.

The window lift mechanism of the present invention has a gear set with at least one pinion gear and at least one worm gear operatively coupled together and supported by the window. The gear set is driven by a motor with an output shaft having a worm which engages the worm gear. The window lift mechanism utilizes a clutch mechanism to increase the efficiency of the torque transfer from the motor to the worm gear in the gear set. The clutch mechanism includes a pair of springs located within the worm gear. This clutch mechanism prevents back drive, hence allowing for the worm on the output shaft of the motor to have a lead angle greater than seven degrees. With a larger worm angle, the amount of torque transferred from the worm to the worm gear is increased, allowing for a smaller motor. The smaller motor reduces the mass of the system.

Further, the gear set in the window lift mechanism of the present invention has a resilient shock absorber operatively engaged between the pinion gear and the worm gear. The shock absorber has surfaces with notched portions to allow for deformation of the resilient shock absorber, which reduces unwanted stress in the gear set and thereby increases the life of the gears.

### BRIEF DESCRIPTION OF THE DRAWINGS

The present invention will become more fully understood from the detailed description and the accompanying drawings, wherein:

FIG. 1 is a schematic view of a window lift mechanism for an automobile door according to the principles of the present invention;

FIG. 2 is a partially cut-away view of the window lift mechanism according to the principles of the present invention;

FIG. 3 is a partially exploded perspective view of a support structure including a window clamp mechanism on the window bracket for the window lift mechanism according to the principles of the present invention;

FIG. 4 is a partially cross-sectional end view of the support structure of FIG. 3 illustrating a cross-sectional view of the window clamp mechanism on the window bracket;

FIG. 5 is a partially exploded perspective view of an alternative support structure including a window clamp mechanism on the window bracket for the window lift mechanism according to the principles of the present invention;

FIG. 6 is an end view of the support structure of FIG. 5 illustrating a cross-sectional view of the window clamp mechanism on the window bracket;

FIG. 7 is a perspective view of a support structure for the window lift mechanism according to the principles of the present invention;

FIG. 8 is a perspective view of an alternative support structure for the window lift mechanism according to the principles of the present invention;

FIG. 9 is a plan view of the main bracket of the dual rack and pinion system according to the principles of the present invention;

FIG. 10 is a front plan view of the main bracket having a motor assembly mounted thereto according to the principles of the present invention;

FIG. 11 illustrates the main bracket being mounted to the dual rack system by drivingly rotating the pinion gears therewith;

FIG. 12 is a front view of the dual rack and pinion system fully assembled according to the principles of the present invention;

FIG. 13 is a perspective view of a modular dual rack and pinion system for mounting to a door of a vehicle;

FIG. 14 is a detailed view of the modular dual rack and pinion system according to the principles of the present invention;

FIG. 15 illustrates a snap-fit engagement between a dual rack system to the frame of the modular assembly;

FIG. 16 shows the dual rack system being mounted to the frame of the modular dual rack and pinion system utilizing threaded fasteners;

FIG. 17A is a schematic view of a dual rack and pinion system utilizing multiple resilient shock absorbers according to the principles of the present invention;

FIG. 17B is a partial perspective view of a dual rack and pinion system utilizing multiple resilient shock absorbers according to FIG. 17A;

FIG. 18 is an exploded perspective view of a slave pinion gear as illustrated in FIG. 17B;

FIG. 19 is a cross-sectional view of the slave pinion gear of FIG. 18 in an assembled condition;

FIG. 20 is a plan view of one of the gear segments of the slave pinion gear of FIG. 18;

FIG. 21 is a graph illustrating the delayed force obtained in a smart motor window lift system utilizing multiple shock absorber according to the principles of the present invention;

FIG. 22 is a graph providing a comparison of force-time distance plots as a window traverses up for a convention window lift mechanism versus a dual rack and pinion system with built-in shock absorbers according to the principles of the present invention;

FIG. 23 is a perspective view of a worm gear/pinion assembly for use with the present invention;

FIG. 24 is an exploded perspective view of the worm gear/pinion assembly of FIG. 23 according to the principles of the present invention;

FIG. 25 is a front perspective view of a pinion gear of the worm gear/pinion assembly;

FIG. 26 is a perspective view of a clutch mechanism of the worm gear/pinion assembly;

FIG. 27a is a front plan view of the resilient shock absorber according to the principles of the present invention;

FIG. 27b is a side view of the resilient shock absorber of FIG. 27a;

FIG. 28 is a front plan view of a support bracket having a motor mounted thereto according to the principles of the present invention;

FIG. 29 is a rear plan view of the support bracket shown in FIG. 28;

FIG. 30 is a rear plan view of the support bracket similar to FIG. 29 with the worm, worm gear, and pinion gears of the drive train being illustrated according to the principles of the present invention;

FIG. 31 is a plan view similar to FIG. 30 with a dual rack mounted to the support bracket according to the principles of the present invention;

FIG. 32 is a detailed perspective view of the dual racks;

FIG. 33 is a cross-sectional view taken along line 33-33 of FIG. 31;

FIG. 34 is a plan view of a dual rack and pinion system for raising and lowering a window according to the principles of the present invention;

FIG. 35 is a plan view of a dual rack and pinion window lift mechanism for raising and lowering a window according to the principles of the present invention;

FIG. 36 is a schematic illustration of the radius of curvature of a window and rack according to the principles of the present invention;

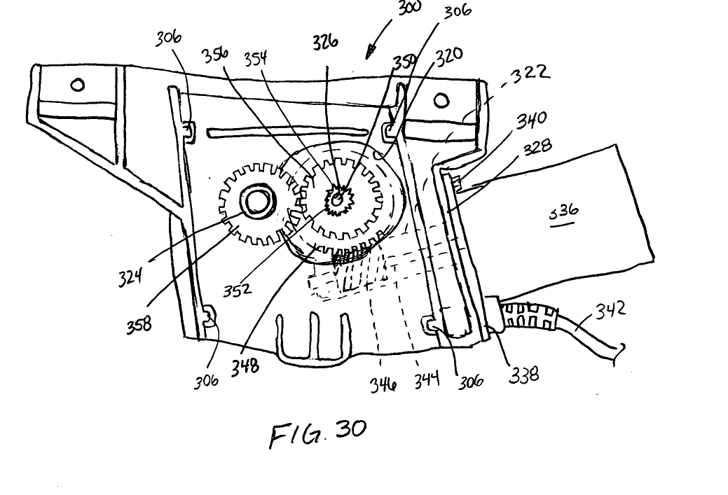

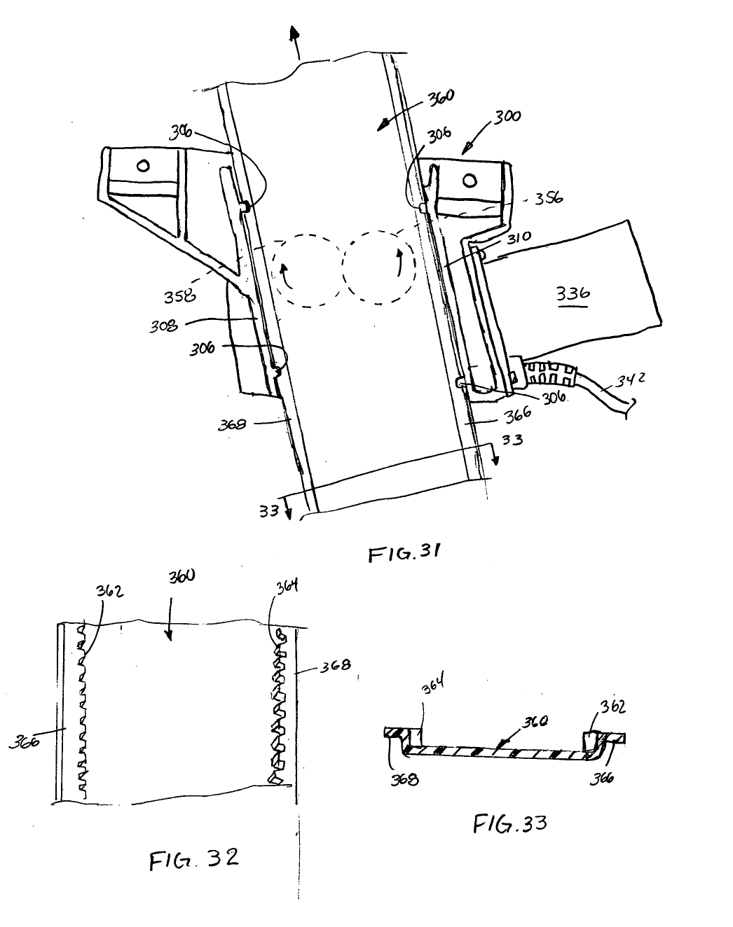

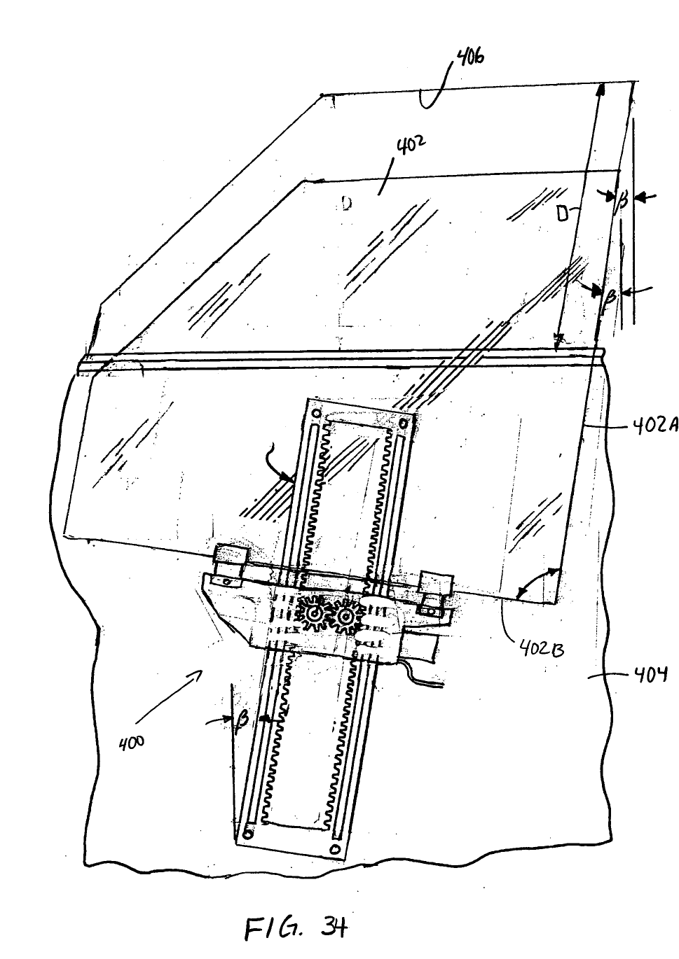

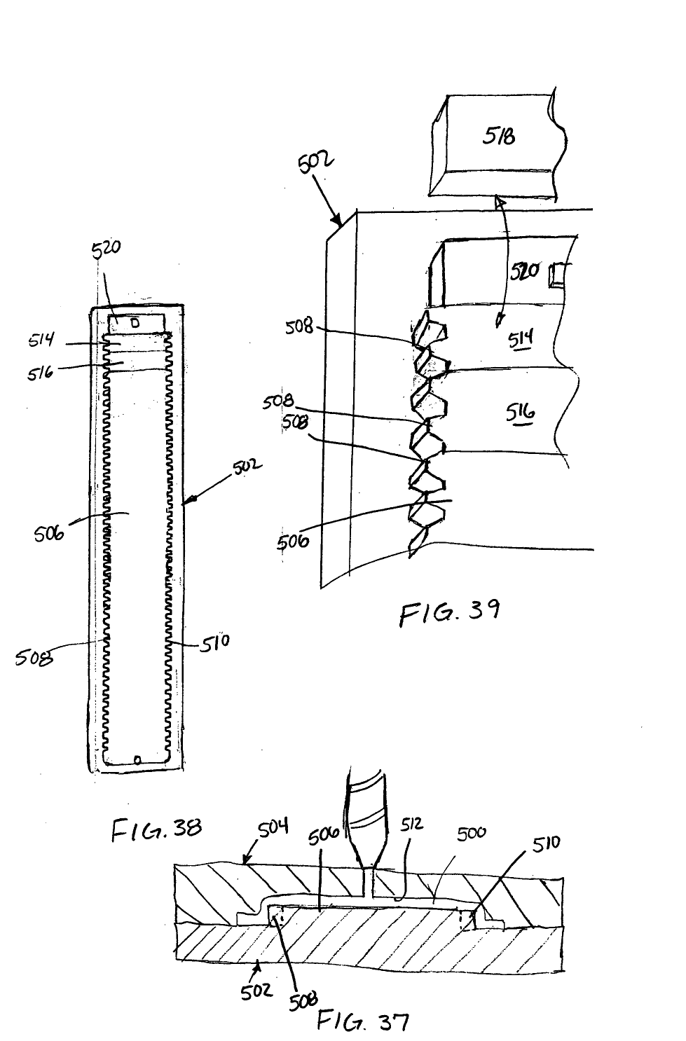

FIG. 34 is a plan view similar to FIG. 30 with a dual rack mounted to the support bracket according to the principles of the present invention;

FIG. 35 is a detailed perspective view of the dual racks;

FIG. 36 is a cross-sectional view taken along line 36-36 of FIG. 35;

FIG. 37 is a cross-sectional view of a mold for forming the dual rack according to the principles of the present invention;

FIG. 38 is a plan view of the bottom plate of the rack mold according to the principles of the present invention; and

FIG. 39 is a detailed perspective view of a portion of the bottom plate of the mold according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

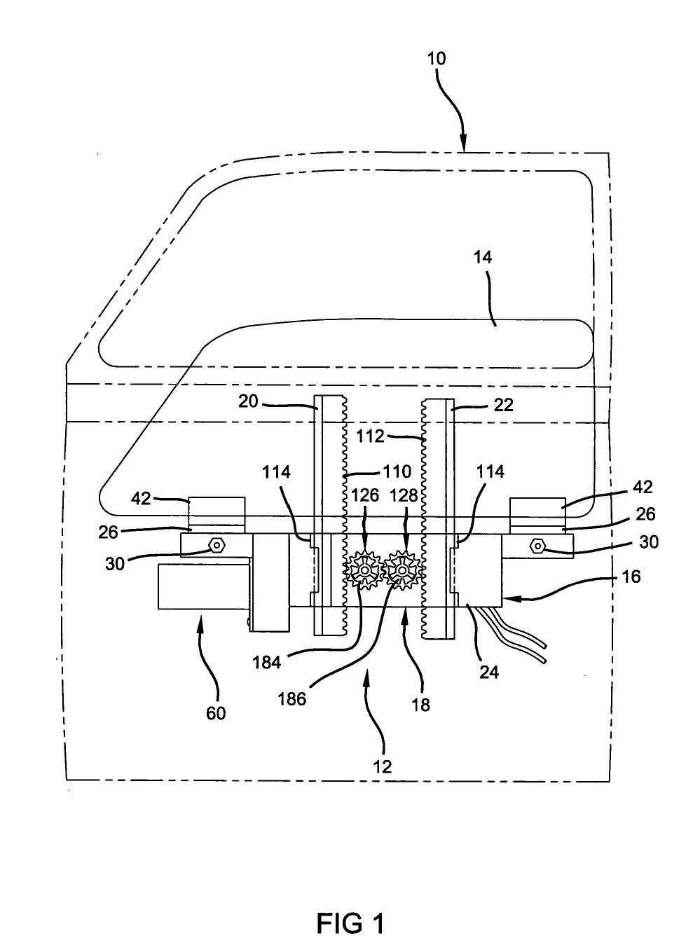

Referring generally to FIG. 1, a vehicle door 10 is shown schematically including a window lift mechanism 12. A window 14 is supported by the window lift mechanism 12 and is located within the automobile door 10. The window lift mechanism 12 includes a support structure 16 and a drive system 18. The drive system 18 is supported by the support structure 16 and serves to drive the support structure 16 relative to a pair of racks 20, 22 which are securely mounted to the door 10.

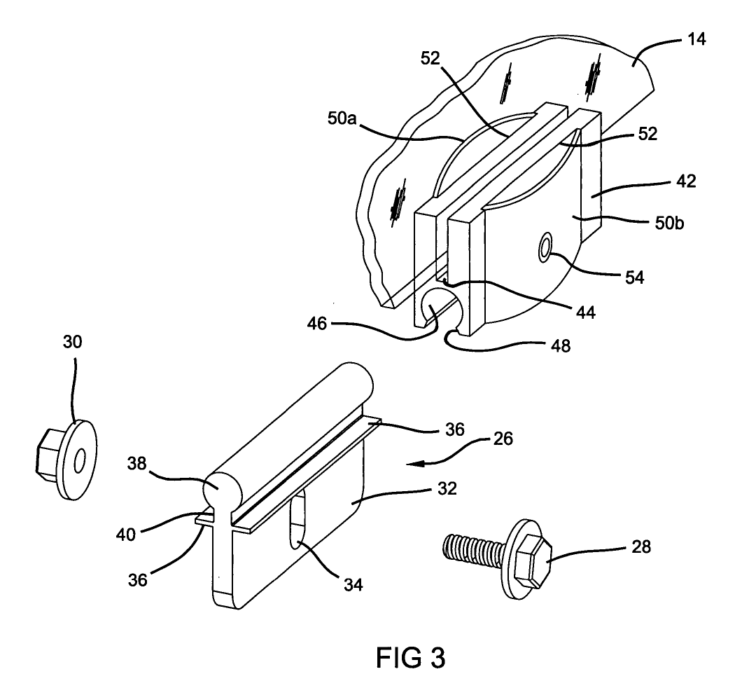

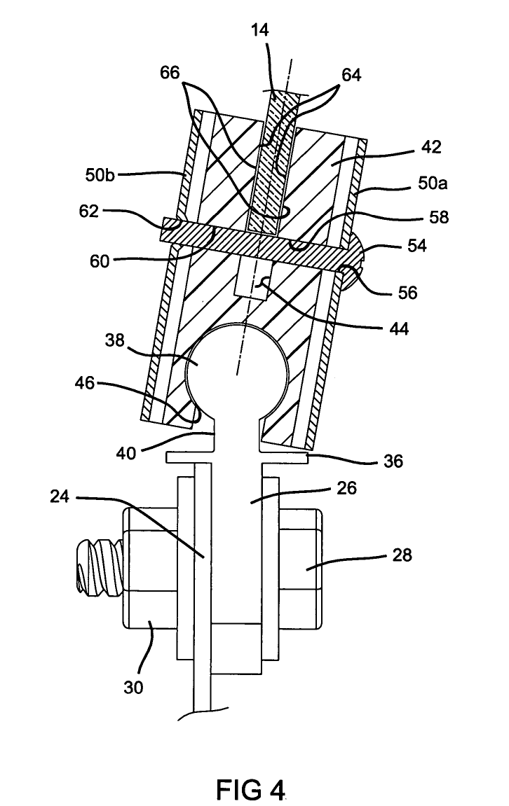

The support structure 16 includes a main bracket 24. According to a first embodiment, a pair of guide brackets 26 (best shown in FIGS. 3 and 4) are mounted to the main bracket 24 by a fastener 28 and a nut 30. The guide brackets 26 include a body portion 32 including an elongated vertical slot 34 for receiving the fastener 28. A pair of opposing stop flanges 36 extend from opposite sides of the body portion 32. An elongated semi-cylindrical guide portion 38 is disposed on an upper neck portion 40 of the guide bracket 26. The support structure 16 further includes a pair of window brackets 42 which are slidably engaged with the guide brackets 26.

The window brackets 42 have a window channel 44 for receipt of the window 14 and a guide channel 46 having a semi-cylindrical inner surface for receiving the semi-cylindrical guide portion 38 of the guide bracket 26, as best shown in FIG. 4a. The guide channel 46 has an opening end portion 48 having a diameter greater than a width of the upper neck portion 40 of the guide bracket 26 so as to allow angular movement (∝)of the window bracket 42 relative to the guide bracket 26, as illustrated in FIG. 4. In FIG. 4, the window bracket 42 is shown tilted in a first forward position and is capable of being moved to a rearward tilted position, as illustrated by the angle∝. The window bracket 42 is able to pivot angularly by a predetermined angular amount ∝ (up to approximately 25°, preferably at least 20°), as well as sliding axially relative thereto in order to accommodate for variances in the door, support structure, and drive system. The interface between the opening 48 and upper neck portion 40, therefore provides the support structure 16 with two degrees of freedom with regard to the axial and rotational adjustment achieved by the guide bracket 26 and window bracket 42. By enabling the window bracket 42 to move with two degrees of freedom relative to the guide bracket 26, the window 14 is allowed to find the path of least resistance during opening and closing. In particular, the two degrees of freedom aids in overcoming unwanted imperfections in the door 10, window 14, support structure 16, and drive system 18. The movement of the window bracket 42 relative to the guide bracket 26 reduces the force placed on the drive system 18 and window 14, as well as reducing the noise generated by the window 14 and drive system 18.

As shown in FIG. 3, the window bracket 42 is mounted to the window by a pair of generally V-shaped metal plates 50A, 50B which are sandwiched on opposite sides of the window bracket 42. The window brackets 42 are provided with recessed channels 52 on opposing faces thereof for receiving the metal plates 50 therein. As best shown in FIG. 4, a threaded fastener 54 extends through an aperture 56 in the first metal plate 50A and through apertures 58 and 60 provided in the window bracket 42. The fastener 54 is threadedly engaged with an internally threaded aperture 62 provided in a second metal plate 50B. By tightening the threaded fastener 54, metal plates 50A, 50B are drawn inward against the side surfaces of the window bracket 42 causing the inner surface of the channel 44 to tightly engage the window 14. The inner sidewalls 64 of the channel 44 are provided with protruding engagement faces 66 at an upper end thereof for engaging the window 14. The recessed surfaces 52 provided on opposite faces of the window bracket 42 provide limit stops for the V-shaped metal plates 50A, 50B which act as spring members for applying a clamping force to the window bracket 42.

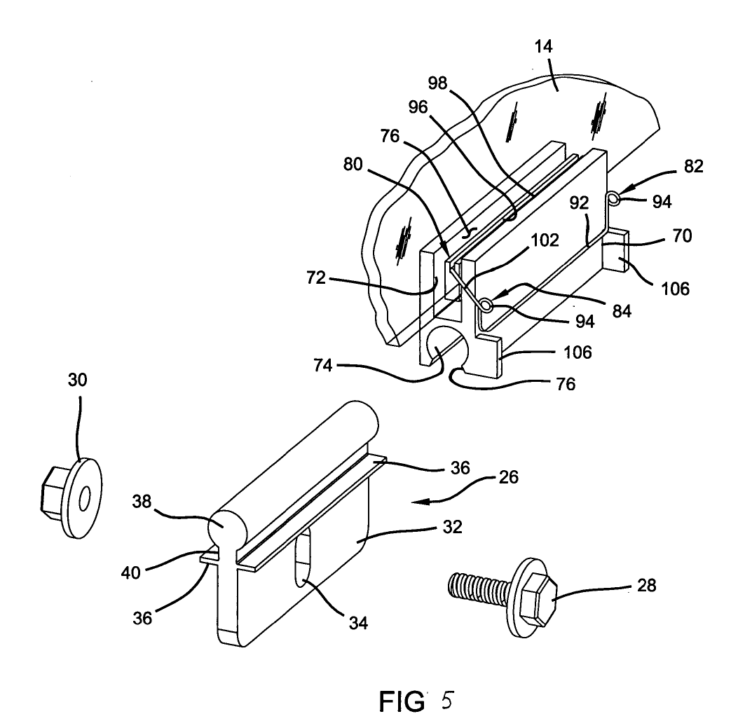

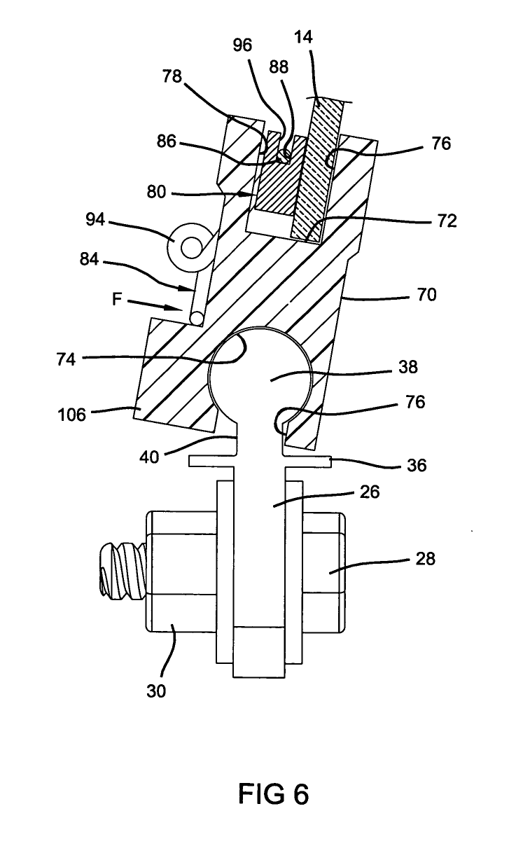

With reference with FIGS. 5 and 6, an alternative window bracket 70 is provided including a window channel 72 for receipt of the window 14 and a guide channel 74 having a semi-cylindrical inner surface for receiving the semi-cylindrical guide portion 38 of the guide bracket 26, as best shown in FIG. 5. The guide channel 74 has an opening end portion 76 having a diameter greater than a width of the upper neck portion 40 of the guide bracket 26 so as to allow angular movement of the window bracket 70 relative to the guide bracket 26, as illustrated in FIG. 6. The channel 72 is provided with a pair of opposing faces 76, 78. The face 78 is angled slightly relative to the face 76. A window 14 is inserted into the channel 72 and is disposed against the face 76 of the channel. A wedge member 80 is inserted in the channel 72 between the window 14 and angled face 78. The wedge member 80 is preferably made of an elastomeric material. A clamping device 82 is provided for applying force to the wedge member 80. The clamping device 82 includes an over-center toggle spring 84 pivotally mounted to the window bracket 70 via apertures 86. The over-center toggle spring 84 includes a pair of spring arms 90 disposed at opposite ends of a cross-bar 92. The spring arms 90 include two end tabs 88 which are received in the apertures 86. The spring arms 90 each include a spiral loop portion 94 which acts as a spring. The wedge member 80 is provided with an elongated channel 96 which receives a cross-bar portion 98 of a clamp wire 100 which includes a pair of opposite arms 102 which extend from the cross-bar portion 98, and each terminate in a hook portion 104 which engage the loop portions 94 of the toggle spring member 84.

During assembly, the window 14 is inserted in the channel 72 and the wedge member 80 is inserted next to the window 14 and sidewall 78 of the channel 72. The cross-bar 92 of toggle spring member 84 is then pulled downward from the position shown in FIG. 5 to the position shown in FIG. 6 until the cross-bar portion 92 of the toggle spring member 84 engages the laterally extending fingers 106 extending from the base of the window bracket 70. In this position, the toggle spring member 84 applies a spring force to the clamping wire 100 that in turn applies a clamping force to the wedge 80 which is biased tightly into the channel 72 for applying a force against window 14. Thus, in this manner, the window bracket 70 is easily mounted to the window 14 for securing the window 14 to the main bracket 24.

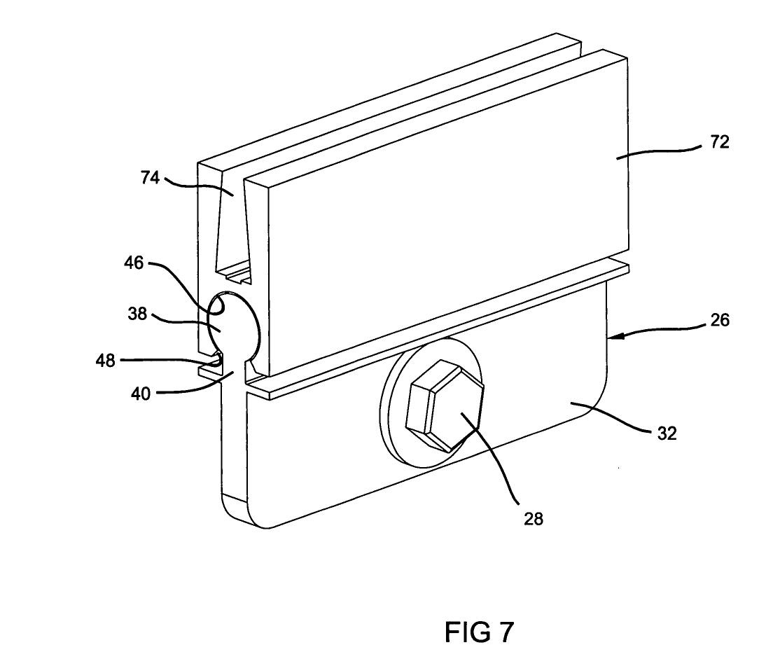

With reference to FIGS. 7-8, alternative designs of the window brackets 7-2 and 8-2, respectively, are shown. As shown in FIG. 7, the window brackets 7-2 have a window channel 7-4 for receipt of the window 14 and a guide channel 46 having a semi-cylindrical inner surface for receiving the semi-cylindrical guide portion 38 of the guide bracket 26, as best shown in FIG. 7. The guide channel 46 has an opening end portion 48 having a diameter greater than a width of the upper neck portion 40 of the guide bracket 26 so as to allow angular movement of the window bracket 42 relative to the guide bracket 26, as illustrated in FIG. 4. As shown in FIG. 8, the window bracket 8-2 can also be mounted to the window 14 by a fastener 8-4.

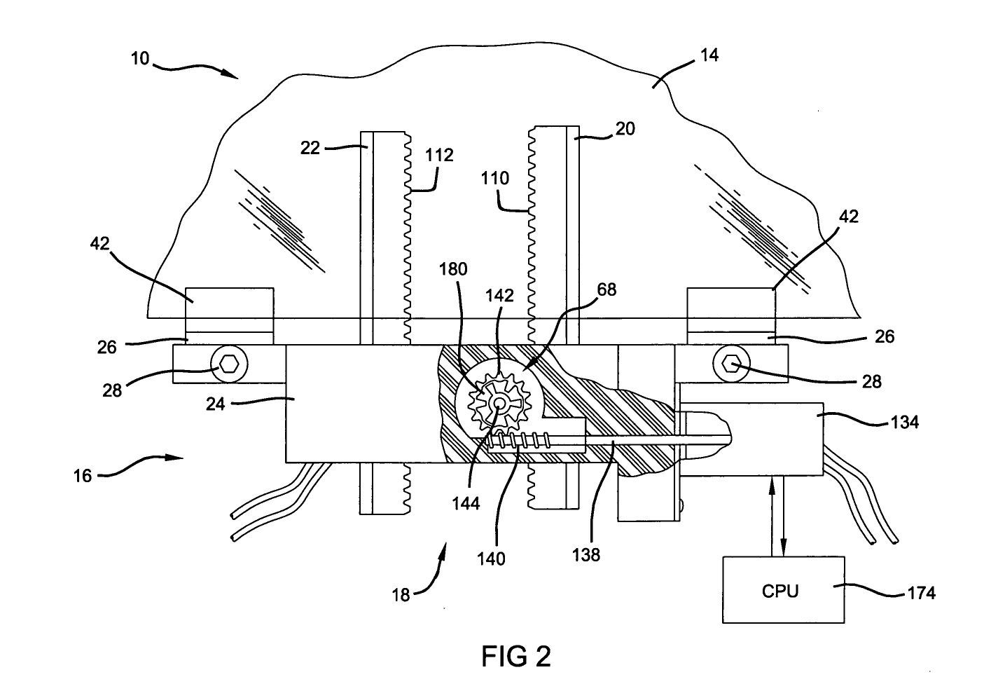

Referring to FIG. 2, the main bracket 24 interacts with the racks 20, 22. The first rack 20 includes a row of teeth 110 which faces a row of teeth 112 on the second rack 22. Teeth 110 and 112 are in engagement with drive system 18 for raising and lowering the window 14. As shown in FIG. 1, guide members 114 are provided on the main bracket 24, adjacent to the first and second racks 20 and 22. Guide members 114 keep the first and second racks 20 and 22 in engagement with the drive system 18. Guide members 114 are generally plastic guide channels integrally formed with the main bracket 24.

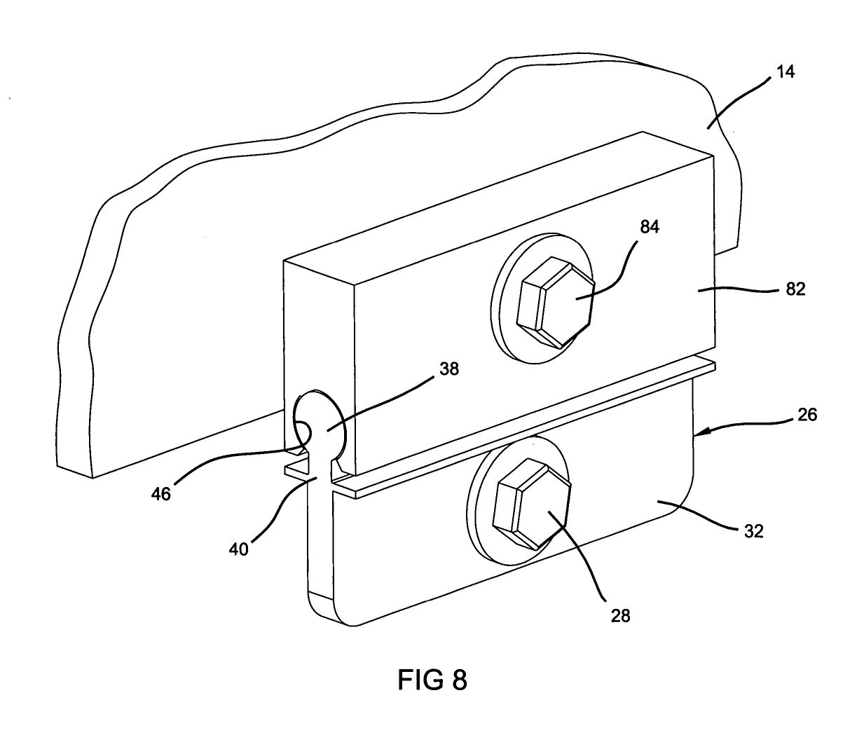

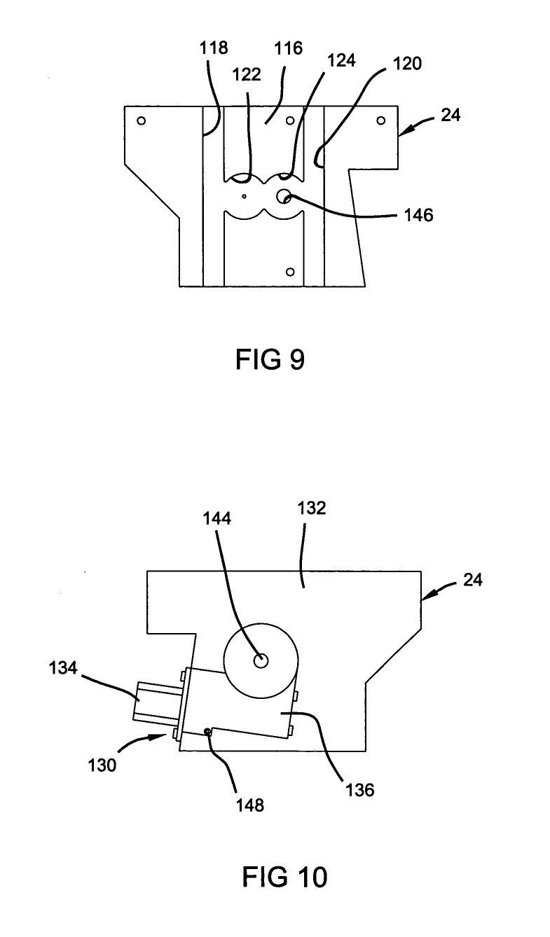

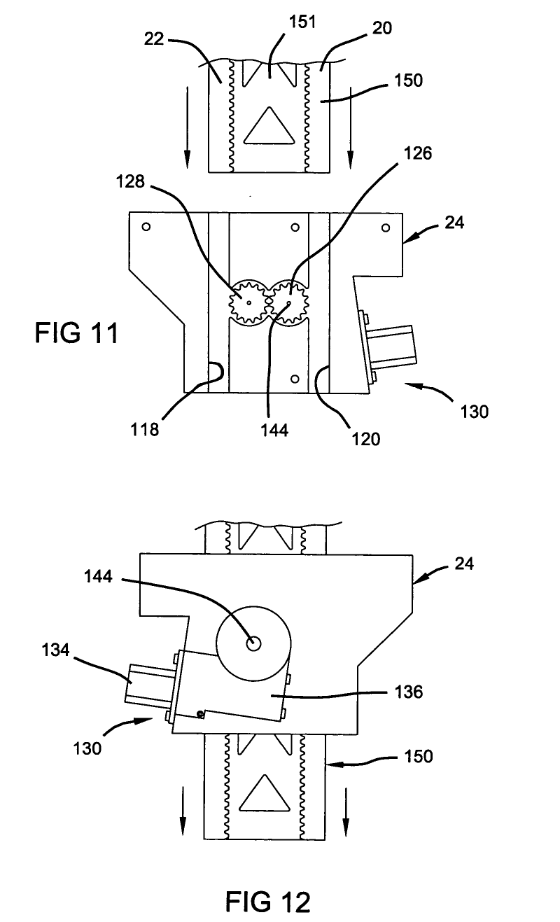

With reference to FIGS. 1 and 2, a general description of the construction and operation of the dual rack and pinion window lift mechanism 12 will now be described. First, the main bracket 24, which is generally shown in FIGS. 1 and 2, is shown in a more preferred arrangement in FIGS. 9-12. In particular, as illustrated in FIG. 9, on a first face 116 of the main bracket 24, a pair of recessed channels 118, 120 are provided as well as recessed portions 122, 124 adapted to receive pinion gears 126, 128 of the drive system, as best illustrated in FIGS. 1 and 11. A motor housing assembly 130 is shown mounted to a second surface 132 of the main bracket 24 in FIG. 10. The motor housing assembly 130 includes a motor 134 connected to a housing 136. The motor 134 is provided with a drive shaft 138 (best illustrated in FIG. 2) having a worm 140 in meshing engagement with a worm gear 142. The worm gear 142 is supported on an axle 144 supported by the housing 136. The axle 144 connected to the worm gear 142 extends through an aperture 146 provided in the main bracket 24, as best illustrated in FIG. 9. During assembly, the motor housing assembly 130 is mounted to the main bracket 24 and is secured in place by threaded fasteners 148 (one of which is shown). After the motor housing assembly 130 is mounted to the main bracket 24, a drive pinion gear 126 is inserted in the recess portion 124 of the main bracket 24 and engaged with the drive spindle 144 of the worm gear 142. In addition, a slave pinion gear 128 is inserted in the recess portion 122 of the main bracket 24 and is in meshing engagement with the drive pinion gear 126. At this time, the motor 134 is connected to an electrical power source and a dual rack system 150 is brought into alignment with the channels 118, 120 of the main bracket 24 and inserted part way until the dual rack system 152 engages the pinion gears 126, 128. At this time, the motor 134 is driven in order to engage the pinion gears 126, 128 with the dual rack system 150, as best illustrated in FIG. 12. The motor is then driven to move the main bracket 24 and motor 134 to a predetermined position for convenient door installation. The dual rack system 150 includes a pair of elongated parallel racks 20, 22 each including a plurality of teeth extending therealong. A lattice-type cross brace structure 151 extends between, and is integrally molded as a unitary piece with, the pair of racks 20, 22. All of the components, except the motor, are made from high precision engineered thermoplastics.

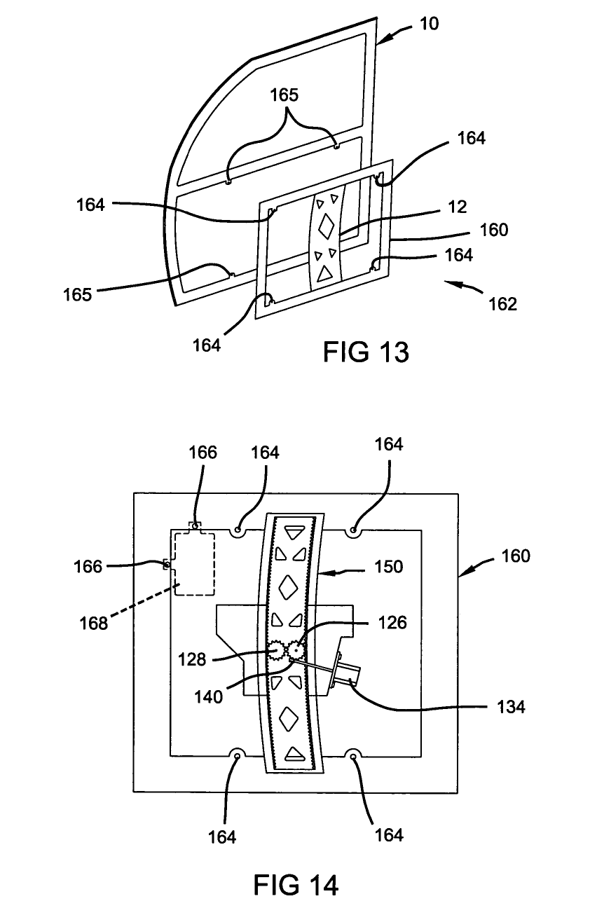

As illustrated in FIGS. 13-16, the dual rack and pinion window lift mechanism 12 is preferably mounted to a frame 160 that allows the frame 160 and window lift mechanism 12 to be mounted into a vehicle door as a modular unit 162, as best illustrated in FIG. 13. As shown in FIG. 14, the dual rack system 150 is preferably molded as an integral piece with the frame 160. The frame 160 is provided with mounting holes 164 which facilitate mounting the modular unit 152 to the vehicle door 10. The door 10 is provided with corresponding mounting holes 165 which are in alignment with mounting holes 164 on the frame 160. In addition, the frame 160 is provided with additional mounting holes 166, as illustrated in FIG. 14, to allow mounting of additional components 168 (shown in phantom) and that can include air bags, speakers, or other door components.

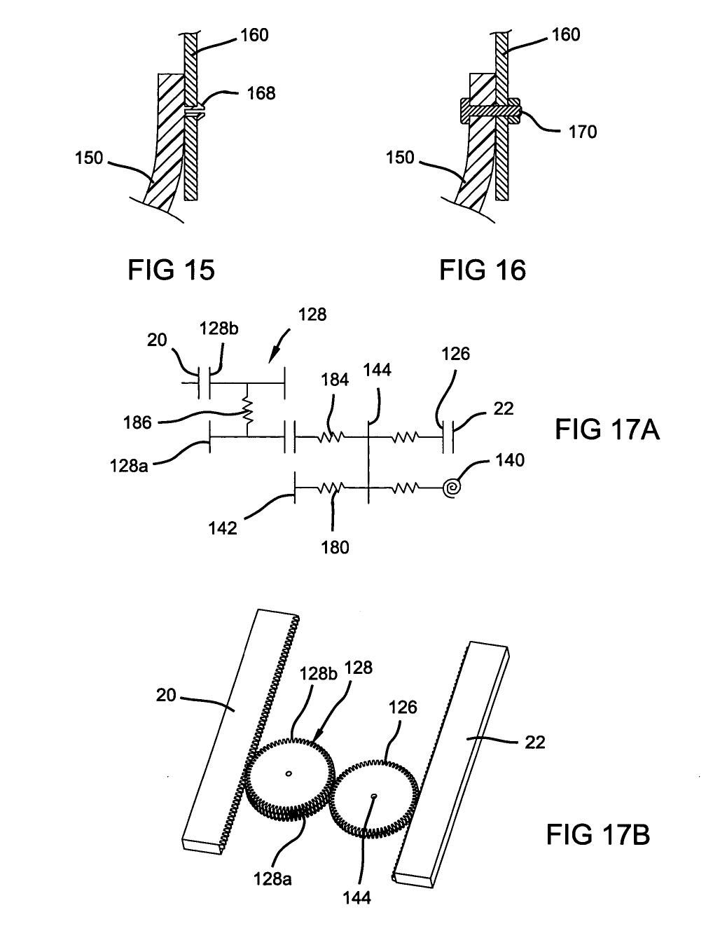

As an alternative to molding the dual rack system 150 integrally with the frame 160, the dual rack system 150 can also be provided with snap-fit engagement for connection to the frame 160 by including snap insert members 168 as illustrated in the cross-section of FIG. 15, or fasteners 170 such as threaded bolts, screws, or rivets can also be utilized for connecting the dual rack system 150 to the frame 160 as illustrated in FIG. 16. The modular unit 162 facilitates easy installation of the window lift mechanism into the door of the vehicle. Once the modular unit 162 is installed in the door, the window 14 can be inserted in the channels provided in the window brackets 42/70, and the window brackets 42/70 are then clamped to the window 14, as described above.

A recent development in power window regulators are referred to as smart regulators, i.e., to have the capability of going up and down fast by touching the switch once. Due to automotive regulations, it is mandatory that on the way up, that from 4 inches to 0.1 inch from the top, the window must be capable of stopping and reversing prior to generating a force in excess of 100 Newtons. To achieve this, manufacturers have utilized sophisticated electronics and memory chips so that the window knows where it is at all times based on past or previous experience. In this way, if the window senses an object in its path, it will know that it is abnormal and hence, reverse. Essentially, detection methods are put in place by using memory chips employed within a controller 174, as illustrated in FIG. 2, so that deviation from a “learned reference” is known. These “learned references” are typically based on motor speed, motor current, or rate of change in speed (acceleration). Electronics used in combination with the memory chips utilize expensive componentry, such as a current shunt, multiple pull magnets, hall sensors, and commutator pulse detection sensors. The cost and performance of the smart units are dependent upon the time available for the motor to “detect and react” to where it was prior to generating forces greater than 100 Newtons. While various smart motor systems have been successfully adapted to arm and sector and cable units, a number of problems exist. Specifically, the design of these systems are such that varying degrees of slack are inherent, and this slack varies continuously and unpredictably over the life of those products. The mechanical inefficiency of those systems requires that larger motors than necessary, typically motors capable of achieving 90 inch pounds plus are utilized which leaves a greater amount of excess force to cause damage to objects that may obstruct the window in the event of malfunctioning of the smart system. Dual rack and pinion regulators are precision manufactured from injection molded engineered thermoplastic, which means that the degree of slack inherent in the system is repeatable, controllable, and based on experience gained, is constant over time. In order to increase the response time available to the smart motor system prior to reaching the 100 Newton force limitation, the dual rack and pinion system of the present invention is provided with a worm gear 142, drive pinion gear 126, and slave pinion gear 128 which are modified to act as shock absorbers. The shock absorbers slow down the pinch process so that a simplified smart motor may have more time to “detect and react” to any interruption in window upward movement.

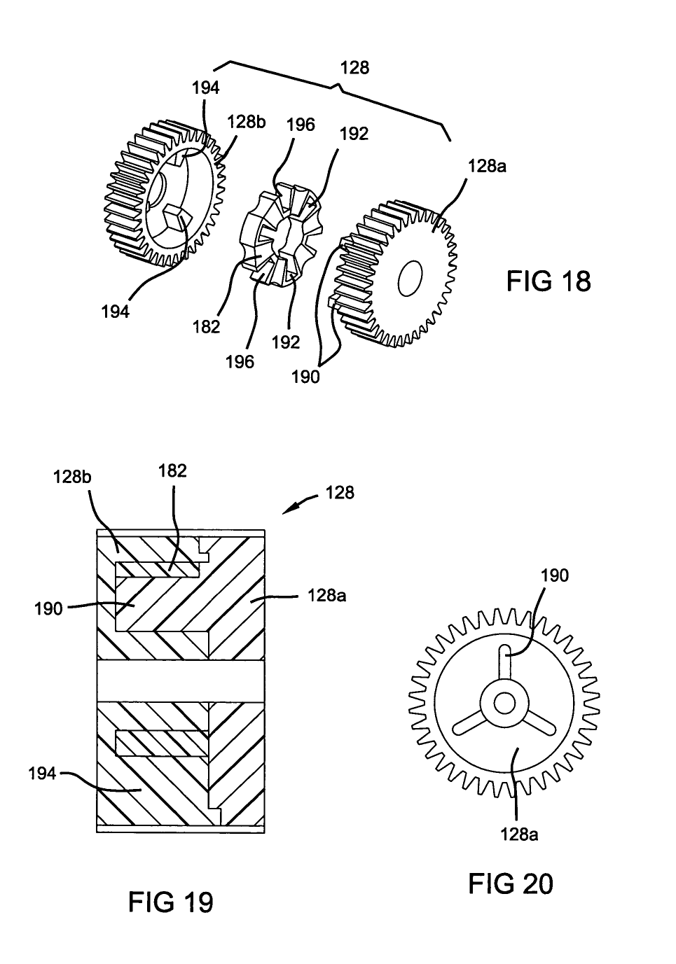

With reference to FIGS. 17-20, a dual rack and pinion system utilizing multiple shock absorbers will now be described. As illustrated in FIG. 17A, a worm 140 is in driving engagement with a worm gear 142. The worm gear 142 is provided in driving engagement with a drive spindle 144 via resilient spring members 180 which can be in the form of elastomeric shock absorber 182 as illustrated in FIG. 18. The drive spindle 144 is drivingly connected to the drive pinion gear 126 via a second resilient spring member 184. As described previously, the drive pinion gear 126 is in driving engagement with the rack 22 of the dual rack assembly 150. Furthermore, the drive pinion gear 126 engages a first gear portion 128A of the slave pinion gear 128. The slave pinion gear 128 includes a second pinion gear portion 128B which is connected to the first pinion gear portion 128A via a resilient spring member 186. The second pinion gear portion 128B of the slave pinion gear 128 engages the rack 20 of the dual rack assembly 150. FIG. 17B illustrates a perspective view of the dual rack and pinion system shown in FIG. 17A. As shown in FIG. 17B, the racks 20, 22 are spaced apart relative to one another.

FIG. 18 illustrates an exploded perspective view of the construction of the slave pinion gear 128, as shown in FIGS. 17A, 17B. In particular, the first gear portion 128A of the slave pinion gear 128 includes a plurality of axially extending fingers 190 which are received in radially outwardly extending recesses 192 of the resilient shock absorber 182. Furthermore, the second gear portion 128B of the slave pinion gear 128 includes a hollow body portion provided with radially inwardly extending fingers 194 which are received in radially inwardly extending recesses 196 of the elastomeric shock absorber 182. With this construction, the shock absorber 182 is capable of absorbing shock forces that are delivered between the first gear portion 128A and second gear portion 128B of the slave pinion gear 128.

With regard to the construction of the worm gear 142 and drive pinion gear 126, it is noted that each of these gears is constructed similar to second gear portion 128B of the slave pinion gear 128. In particular, each of these gears include radially inwardly extending fingers, such as fingers 194, which engage an elastomeric shock absorber such as shock absorber 182 illustrated in FIG. 18. The drive shaft 144 is provided at each end thereof with radially outwardly extending fingers, similar to fingers 190. It should be noted that other constructions using torsion springs or other elastomeric members having different configurations may also be utilized with the present invention. Similar systems utilizing stress dissipation technology are disclosed in commonly assigned U.S. Pat. Nos. 5,307,705, 5,452,622, and 5,943,913 for providing shock absorbance in a gear system.

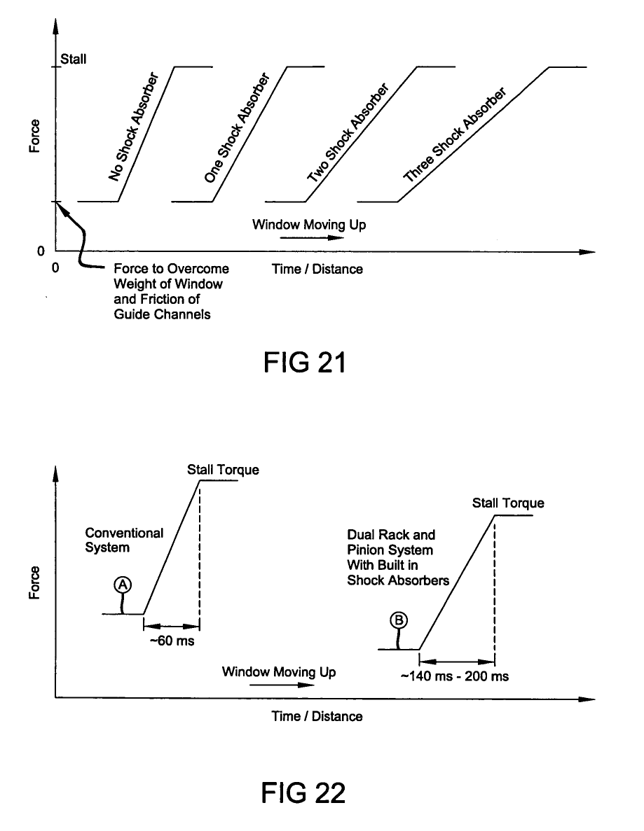

When a shock absorber system is utilized in combination with a smart motor system and the upward moving window is obstructed and generates an impulse determined by force multiplied by time (Fxt) the shock absorbers increase the time factor, hence reducing the applied force at any point in time. With reference to FIG. 21, the influence of shock absorbent on the force versus distance/time plot as a window traverses up, is illustrated graphically for a dual rack and pinion system utilizing different numbers of shock absorbers (0-3). As illustrated in the drawings, the use of each additional shock absorber increases the time that is available prior to reaching a stall force for the motor. This increase in time, due to the use of multiple shock absorbers, increases the ability of a smart motor to prevent the window from reaching a predetermined maximum force level. Accordingly, the componentry of the smart motor can be reduced in complexity and cost due to the additional time allotted for reaction to the detected force. An additional benefit of the use of multiple shock absorbers is that they reduce the amount of vibration transferred from components of the gear train to the next and, therefore, reduce the noise generated by the dual rack and pinion system.

FIG. 22 graphically illustrates a typical arm and sector and/or cable system as compared to the dual rack and pinion system with built-in shock absorbers. It is noteworthy that existing arm and sector and cable units also have shock absorbers built into the worm gear of the system. As illustrated in FIG. 22, typical arm and sector and/or cable systems require higher amounts of force which are required to overcome gravity and guide friction as illustrated by point A on the line representing the conventional system. In comparison, for the dual rack and pinion system with built-in shock absorbers, the amount of force required to overcome the window weight and guide channel resistance is significantly less as illustrated by point B. In addition, because of the increased efficiency of the dual rack and pinion system, the system can be provided with a smaller motor which reduces the amount of torque applied by the system and therefore, reduces the amount of potential torque that can be applied to an obstruction in the window. A typical dual rack and pinion system utilizes a motor which uses approximately 65 inch pounds of torque as compared to an arm and sector or cable system which utilizes a motor capable of producing upward of 90 inch pounds of torque. Finally, the amount of time from hitting an obstruction until a stall torque is obtained for a conventional system is approximately 60 milliseconds, whereas for the dual rack and pinion system this time is approximately 140 to 200 milliseconds when utilizing built-in shock absorbers. The more time provided for detection of an obstruction, allows the use of a less complex and hence, more economic smart regulator system.

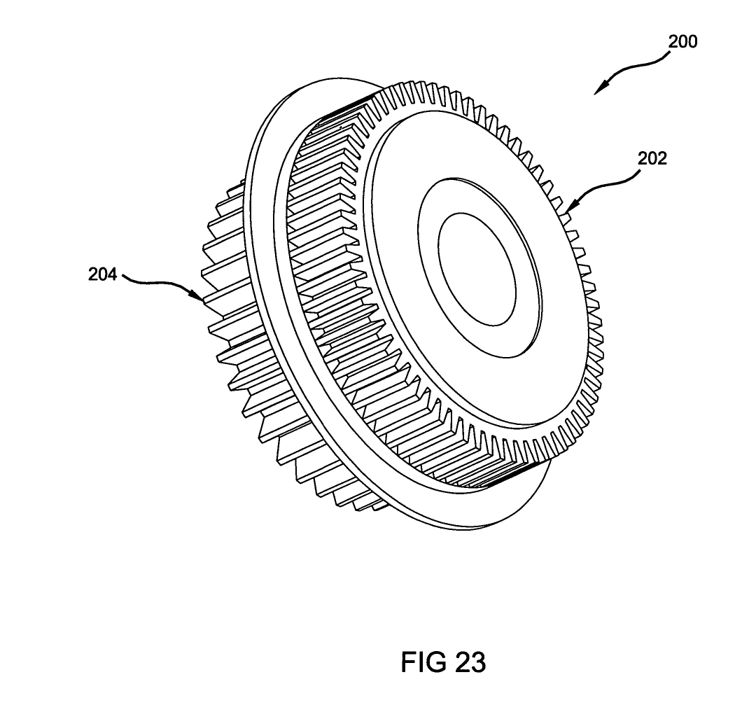

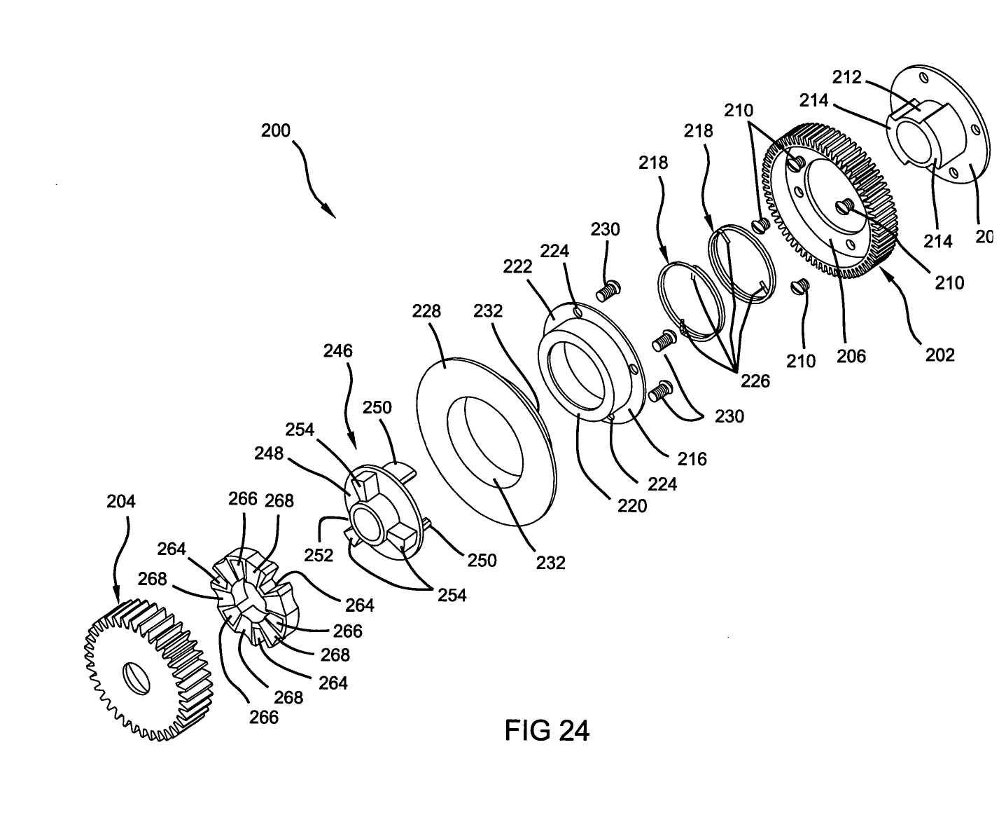

With reference to FIGS. 23 and 24, an alternative design of the first worm gear/pinion assembly 200 includes the first worm gear 202 and the first pinion gear 204. The worm gear 202 includes an inwardly extending flange portion 206, best shown in FIG. 24. A worm gear hub portion 208 is attached to the flange portion 206 of worm gear 202 by a plurality of fasteners 210. The hub portion 208 includes a keyed shaft portion 212 including two semi-cylindrical protrusions 214 extending radially therefrom. The shaft portion 212 is received in a spring retainer 216 which includes a pair of clutch springs 218 within an angular body portion 220 thereof. A radially extending flange 222 extends from the annular body portion 220 and includes a plurality of apertures 224 therein.

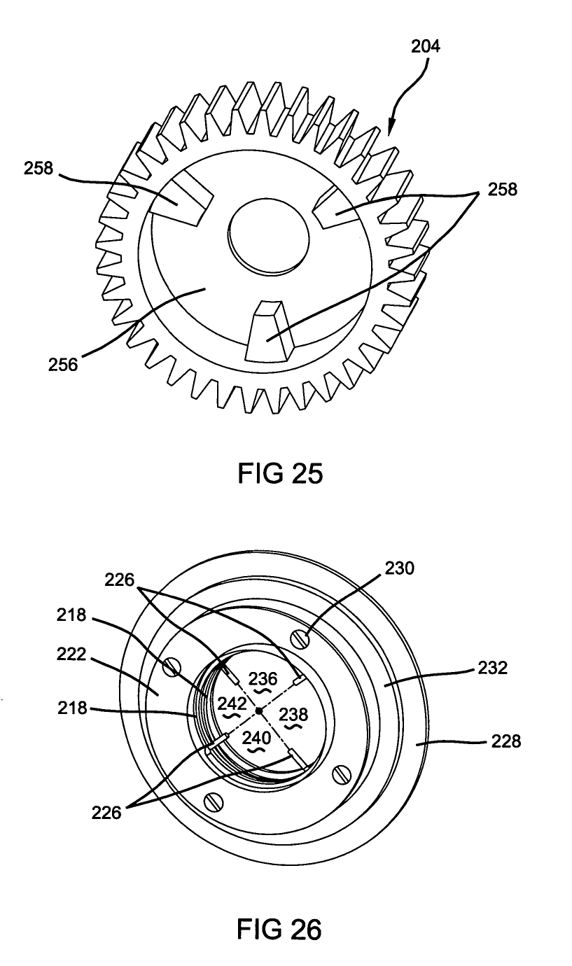

The clutch springs 218 each include a helically wrapped spring wire having two end fingers 226 extending radially inward. The end fingers 226 of each clutch spring 218 are disposed opposite one another. The clutch springs 218 are received within the annular body portion 220 of the spring retainer 216 and are arranged at 90 degree offsets from one another in order to define four separate quadrants 236, 238, 240, 242 (best shown in FIG. 25) between the end fingers 226 of the two clutch springs 218. The spring retainer 216 is mounted to a clutch housing 228 by threaded fasteners 230 extending through apertures 224 in the flange 222 of the spring retainer 216. Threaded fasteners 230 engage threaded apertures (not shown) that are provided on the face of the clutch housing 228. The clutch housing 228 includes an axially extending hub portion 234 in which the annular body portion 220 of spring retainer 216 is received.

With reference to FIG. 26, the clutch assembly is shown including the spring retainer 216 disposed within the clutch housing 228 and clutch springs 218 having end fingers 226 each extending radially inward and defining the four generally equally spaced quadrants 236, 238, 240, and 242. The axially extending shaft portion 212 of the worm gear hub portion 208 extends into the clutch housing 228 such that the radially extending semi-cylindrical protrusions 214 are each received within an opposing quadrant (for example, quadrants 236, 240). The clutch springs 218 are arranged such that when the motor is being driven, the clutch springs 218 rotate within the housing 228. However, when the motor is stationary, forces applied to the springs 218 by the drive train tend to cause the springs to expand and thereby prevent the springs from rotating.

A shock absorber bridge 246 is provided with a disk shaped body portion 248 having a pair of axially extending semi-cylindrical fingers 250. The semi-cylindrical fingers 250 extend into the clutch housing 228 and are received in opposing quadrants 238, 242 defined by the end fingers 226 of clutch springs 218. The shock absorber bridge 246 also includes a cylindrical protrusion 252 extending from a second side of the disk shaped body 248 and includes three radially extending triangular protrusions 254 extending from the cylindrical protrusion 252. The cylindrical protrusion 252 and triangular protrusions 254 of shock absorber bridge 246 are received within an interior cavity 256 of pinion gear 204. As best shown in FIG. 25, pinion gear 204 includes radially inwardly extending protrusions 258 extending inwardly within the cavity 256. A resilient shock absorber 262 is disposed between the pinion gear 204 and the shock absorber bridge 246. The resilient shock absorber 262 is made from an elastomeric material such as santroprene 55. The resilient shock absorber 262 includes three triangular cutouts 264 extending radially inward from an outer surface thereof for receiving the radially inwardly extending protrusions 258 of the pinion gear 204. The resilient shock absorber 262 also includes three triangular cutouts 266 which extend radially from the inner surface of the resilient shock absorber 262 for receiving the radially outwardly extending protrusions 254 of the shock absorber bridge 246.

The resilient shock absorber 262 is pressed into the cavity 256 of the pinion gear 204 so that the inwardly extending protrusions 258 of the pinion gear 204 are received in the radially inwardly extending cutouts 264 of the resilient shock absorber 262. The cylindrical protrusion 252 and radially extending protrusions 254 are inserted in the central opening of the resilient shock absorber 262 and the radially extending cutouts 266, respectively. The resilient shock absorber 262 is provided with a plurality of body sections 268 which are each disposed between a radially inwardly extending cutout 264 and a radially outwardly extending cutout 266.

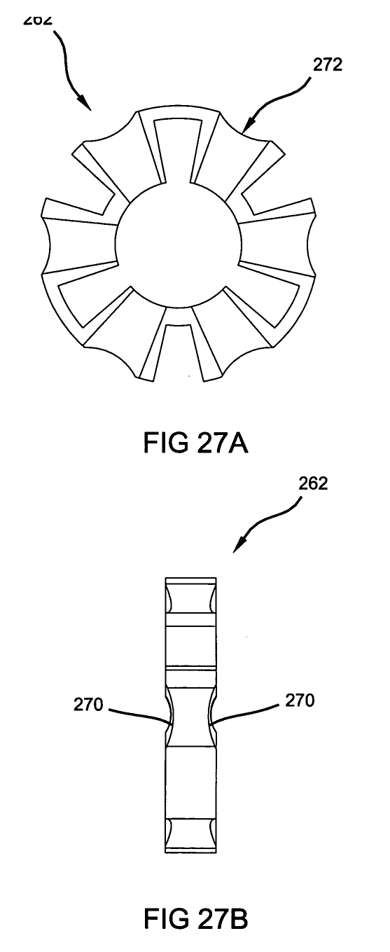

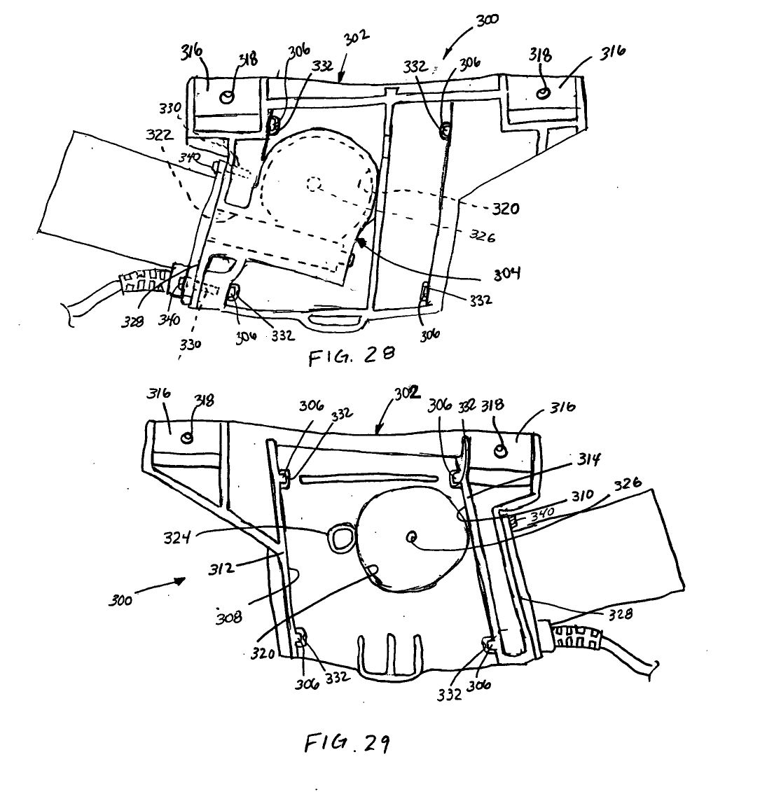

Due to the limited space in the cavity 256, the side surfaces and radial surface of the body sections 268 are notched inwardly to accommodate for deformation. Specifically, elastomeric materials have a Poisson's ratio of approximately 0.5, and therefore, under compression and/or tension, the volume of the material is retained. Hence, inward deformation in one direction causes the material to bulge outward in other directions. Thus, compression of the resilient shock absorber 262 in the lateral direction will cause the elastomeric material to deform or bulge outward in the axial and radial directions. Thus, in order to accommodate for the bulging of the elastomeric material under compression, the notched surfaces 270, 272 allow room for deformed elastomeric material to move into. If the notches were not provided, non-optimum force deflection occurs since the efficiency of the resilient shock absorber 262 is directly related to the amount of deflection at any applied force. Thus, a preferred design is one which allows the volume to be maintained. As shown in FIGS. 27a and 27b, the notched side surfaces 270 are best shown in the side view of FIG. 27b and the notched radial surfaces 272 are best shown in plan view of FIG. 27a. Within the first worm gear/pinion assembly arrangement 200, the optimum design of the resilient shock absorber 262 is achieved by sculpting both the radially outward surface with notches 272 and each face with notches 270. This sculpting allows proper deflection of the resilient shock absorber 262 and thereby prevents unwanted stress on the worm gear/pinion assembly 200, which increases the life span of the assembly.

During operation, the motor 60 drives driveshaft 138 and worm 140 which in turn rotates the worm gear 202. The worm gear 202 has the internal shaft portion 212 of gear hub portion 208 fixedly attached thereto for rotation therewith. As the shaft portion 212 rotates, force is transmitted through clutch springs 218 via engagement of the end fingers 226 engaging with the radially extending semi-cylindrical protrusions 214. The end fingers 226 thereby transmit rotation to the shock absorber bridge 246 via axially extending fingers 250. The shock absorber bridge 246 then transmits rotation to the pinion gear 204 via the resilient shock absorber 262. The resilient shock absorber 262 absorbs forces that are applied through the drive system 18 in order to prevent damage to components of the drive system 18, the support structure 16, or window 14.

Worm 140 is helical and directly engages the teeth of the first worm gear 202. The lead angle of the worm 140, according to a preferred embodiment of the present invention, is greater than seven degrees. Typically, a worm lead angle in such a system is required to be less than or equal to seven degrees, as a necessity in order to prevent backdrive. However, in these systems, the efficiency of the torque transferred from the worm to the worm gear tends to be low due to the low lead angle of the worm. In systems with low efficiency, a larger motor is needed to create more torque to overcome the inefficiencies in the system. In the present invention, however, the clutch mechanism in the form of clutch springs 218 is provided in order to allow the lead angle of the worm 140 to be increased greater than seven degrees in order to improve the efficiency thereof while the clutch mechanism prevents system backdrive. By increasing the lead angle of the worm 140, the efficiency of the torque transferred from the worm 140 to the worm gear 202 is increased, hence allowing for the use of a smaller motor 60.

The system of the present invention provides an improved, more efficient window lift mechanism wherein variations in the door and lift mechanism are accommodated for by the two degrees of freedom allowed for by the guide bracket and window bracket interface. In addition, the clutch mechanism, which is housed within the interior space of the worm gear 202 allows for the lead angle of the worm gear 202 to be increased for improved efficiency while preventing undesirable back drive from occurring with the increased lead angle utilized on the worm. Finally, the improved resilient shock absorber 262 being provided with notched surfaces to allow for displacement of the resilient material when loaded under compression, also leads to a more efficient shock absorber. The worm gear/pinion assembly is also provided with a compact arrangement since the worm gear and pinion can be disposed side by a side with a majority of the clutch structure and shock absorber structure being maintained within the interior compartments defined by the worm gear 202 and pinion gear 204.

With reference to FIGS. 28-31, a support bracket 300 for a window lift mechanism is shown and includes a cross bar portion 302 and transmission housing portion 304 formed as a single unitary piece. The cross bar portion includes a plurality of rack guide features such as fingers 306 disposed on opposing faces 308, 310 of guide rails 312, 314, respectively, on the rear side of the support bracket 300 as shown in FIG. 29. As illustrated in FIGS. 28 and 29, the support bracket 300 is provided with apertures 332 surrounding the fingers 306 in order to facilitate the molding of the finger portions 306, as is understood by one having ordinary skill in the art. The cross bar portion 302 includes a pair of window bracket mounting features 316 each provided with an aperture 318 extending therethrough for receipt of a mounting fastener (not shown). On the rear side of the support bracket as illustrated in FIG. 29, the transmission housing portion 304 includes a recessed gear cavity 320 (also illustrated in phantom in FIG. 28). As illustrated in FIG. 28, the transmission housing portion 304 includes a passage 322 (illustrated in phantom) and in communication with the recessed gear cavity 320.

As illustrated in FIG. 29, a slave gear hub portion 324 is provided adjacent to the recessed gear cavity 320. The recessed gear cavity 320 includes a central aperture or bore 326. The transmission housing portion 304 also includes a motor mounting structure 328 defining a flat surface through which the passage 322 extends. A pair of recessed threaded bores 330 are provided on opposite sides of the motor mounting surface 328.

With reference to FIG. 30, assembly of the motor and transmission unit will now be described. First, the motor 336 including a flange portion 338 is mounted to the motor mounting surface 328 by fasteners 340 threadedly engaging threaded bores 330. Motor 336 includes a cord 342 for connecting the motor 336 to the vehicle's electronic system, as is well known in the art. The motor 336 includes a drive shaft 344 which extends into the passage 322 and includes a worm 346 disposed thereon, as illustrated in phantom. As illustrated in FIG. 30, the worm 346 extends into the recessed gear cavity 320. A worm gear 348 is inserted into the recessed gear cavity 320 and is drivingly engaged with the worm 346. A drive spindle 350 is press-fit into the bore/aperture 326 for rotatively supporting the worm gear 348. The worm gear 348 includes a splined hub portion 352 which is received in an internally splined aperture 354 provided in the first pinion gear 356 for providing a driving connection between the worm gear 348 and first pinion gear 356. A second pinion gear 358 is then inserted on the slave gear hub portion 324 and in meshing engagement with the first pinion gear 356.

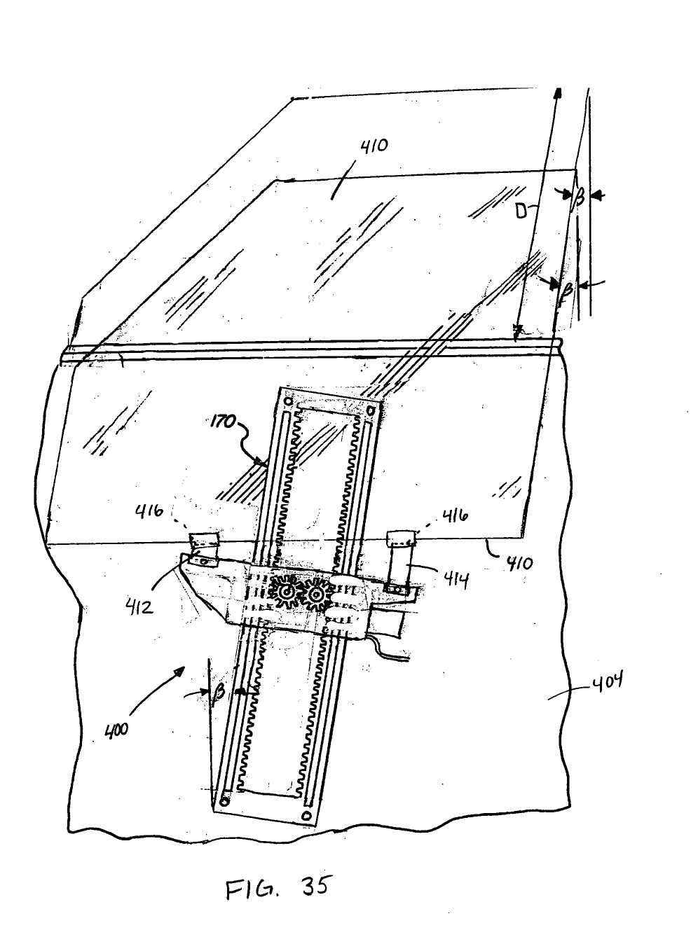

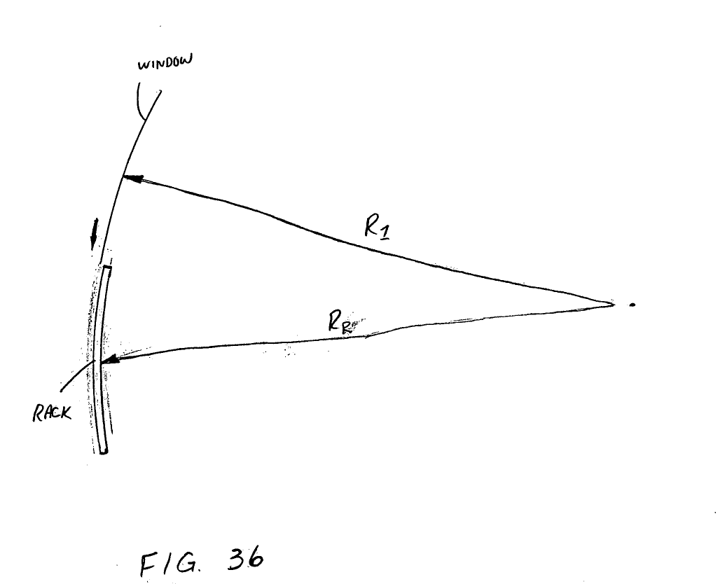

After the first and second pinion gears 356, 358 are assembled, a dual rack 360 (illustrated in FIGS. 31-33) is then aligned with the pinion gears 356, 358 and electrical power is supplied to the motor 336 to drive the rack 360 into engagement with the pinion gears 356, 358. As illustrated in FIG. 32, the front face of the rack 360 includes a first elongated set of rack teeth 362 which are drivingly engaged with the first pinion 356 and a second elongated set of rack teeth 364 which are engaged with the second pinion gear 358. As illustrated in FIG. 33, a cross-sectional view of the rack 360 taken along line 33-33 of FIG. 31 is shown. As illustrated in FIG. 33, the rack 360 includes rack teeth 362 and 364 extending parallel to one another as well as elongated guide flanges 366, 368 extending along opposite sides of the rack 360. Guide flanges 366, 368 are received under the rack guide features 306 and between guide rails 308, 310 such that the first and second pinion gears 356, 358 are received between the first and second sets of rack teeth 362, 364.

With the disclosed support bracket 300, the assembly of the window lift mechanism is greatly simplified by eliminating the need to mount the transmission housing to the cross bar portion as a separate unit. Thus, the reduction of the number of parts by combining the transmission housing and cross bars also reduce the number of fasteners required to mount the transmission housing to the cross bar portion. The reduction in the number of assembly steps therefore corresponds to a reduction in assembly costs associated with the dual rack and pinion window lift mechanism. The combining of the transmission housing and cross bar into a single mold also reduces the number of separate molds and separate molded articles that need to be made. Thus, there is a significant reduction in capital expenditure for reducing the number of molds necessary for molding the component parts of the dual rack and pinion system. By combining the cross bar portion and transmission housing portions, a reduction in the total amount of raw material required is achieved, therefore, reducing the weight and cost of the system. Finally, because all of the mounting structure such as bore 326 for supporting the shaft 350 and slave gear hub portion 324 are molded into a single component, the consistent reproducibility of parts and consistent assembly is achieved.

Previously, in designing rack and pinion power regulators for any particular door model, the angle of the B and A-pillars on the front and rear doors, the radius of curvature of the window, the length of the window travel, and the distance of the safety bar inner surface from the outside surface of the glass were considered. Using these criteria, the racks of prior dual rack and pinion systems have been specifically designed to be angled to match the angle of the B-pillar while the support rack was specifically designed to be generally horizontal relative to the angled rack for supporting the horizontal bottom edge of a window pane. Furthermore, the radius of curvature of the rack was designed to specifically match the radius of curvature of the window as well as the length of the racks being provided to specifically match the distance of travel of the window panel.

Previously, as the guide angles between the moving cross bar and rack has needed to match the A and B-pillar angles and as the radius of curvature of the rack match the radius of curvature of the window, it was necessary that a new and separate set of cross bar molds and rack molds be built for each and every door design. For convenience and economic reasons, the rack and cross bar molds are typically built with a right and left hand cavity so that from a single injection shot, individual parts are obtained for the driver side and the passenger side regulators. An additional set of molds would, of course, have to be built for the rear doors on a four-door vehicle. A complete set of molds for a four-door vehicle typically costs approximately $400 thousand and has the capability of generating approximately 1.5 million regulator part sets per year in a 24-hour, six-day work week. Additionally, an automated testing and assembly line which attaches gears to the cross bar and the cross bar to the rack and tests the full up and down travel of the system costs approximately $300 thousand, and can also handle approximately 1.5 million regulators per year in a 24-hour, six-day work week. Those assembly lines are somewhat universal, and may be used to accommodate different vehicle regulators. Therefore, typically for a four-door vehicle, a capital outlay of approximately $700 thousand is required to accommodate molding, assembly, and pre-shipment testing of component parts.

For costing purposes, the capital expenditure is typically amortized over the life of the product. Car models generally sell less than three-quarters of a million units annually, therefore, dedicated molds are greatly under utilized and consequently the amortization associated with each regulator produced is higher than it needs to be if there was a way to fully utilize each set of molds built; i.e., if the same mold set could be used for different car models and/or if the same mold set could be used for front and rear doors.

As illustrated in FIG. 34, a dual rack and pinion window lift mechanism 400 is provided for raising and lowering a window 402 provided in a vehicle door 404. The window 402 is received in a window opening 406. The window 402 has a rear edge 402A which is provided with a B-pillar angle β which is typically between 0 and 15 degrees, although other negative angles as well as larger positive angles may be utilized depending upon the vehicle design. In previous designs, the dual rack had been specifically designed to be angled so as to match the B-pillar angle β and the support bracket had been specifically designed to remain generally horizontal while traversing the angled rack so as to engage with a generally horizontal bottom edge of the window. Vertical racks were typically used only for window applications when the B-pillar angle was zero (a vertical B-pillar). However, with the system shown in FIG. 34, a universal unangled (vertical) rack and support bracket can be mounted at an angle β, as illustrated, to match the B-pillar angle with the bottom edge 402B of the window panel 402 being generally perpendicular to the B-pillar angle so that the use of a straight (vertical) dual rack and pinion regulator can be utilized to drive the window efficiently up and down along the B-pillar angle β. With the design of FIG. 34, the universal (vertical) rack can be utilized without needing to specifically design the rack and support bracket for use with a window having an angled B-pillar. A vertical rack of this type is typically used where the B-pillar angle is vertical. Now, the use of a vertical rack can be utilized where the B-pillar angle is greater than zero.

According to an alternative design, as illustrated in FIG. 35, the dual rack and pinion system 400 is mounted in parallel to the B-pillar angle β in the same manner as shown in FIG. 34. However, in this embodiment, the bottom edge 410B of the window 410 is generally horizontal, while the attachment brackets 412 and 414 are modified with a shorter bracket 412 in the front, and a longer bracket 414 in the back each having an angled slidable interface 416 of the type shown previously in FIGS. 3 and 4, in order to retain the same result as in the embodiment of FIG. 34. The added cost of changing the shape at the bottom of the glass 402B and/or increasing/decreasing the bracket lengths 412, 414 to achieve the same result is miniscule in comparison to the time and dollar savings associated with reduced capital expenditures due to the reduced number of molds required due to the increased utilization of the mold and automated assembly line due to the use of a universal, vertical rack and support bracket system. It should be noted that the systems of FIGS. 34 and 35 can be utilized with either front or rear door windows in which either the forward or rearward pillar serves as the guide pillar along which the window travels. The universal rack is therefore mounted parallel to the guide pillar.

Changing the shape; i.e., the angle at the bottom of the glass, and/or matching respective bracket lengths to achieve the desired result allows for the universality in relation to the B-pillar design element criteria. With regard to the design criteria element relating to the variations in the radii of window curvature from one model window to the next, it is noted that these variations may be conveniently satisfied by taking advantage of the controlled flexibility naturally built into the plastic flexible rack designs, and by utilizing the back and forth freedom of motion inherently built into the design of the dual action brackets such as illustrated in FIGS. 3 and 4. Thus, when designing dual racks with a dual rack and pinion window lift mechanism that is desirably going to be used for multiple window configurations having differing radii of curvature for the different window designs, it is desirable to select a radius of curvature R_{R} for the rack to be used with a first window having a radius of curvature R₁ and a second window having a radius of curvature R₂ such that the radius of curvature RR of the rack is between the first and second radii of curvature R₁ and R₂ for the first and second window designs (see FIG. 36). Ideally, the radius of curvature RR of the rack would be approximately an average of the radii of curvature of the first and second windows R₁ and R₂.

With regard to the design criteria element addressing the glass travel distance, variances in glass travel may be conveniently provided for by using incremental inserts 514, 516, 518, 520 within a universal rack mold so that different rack lengths may be obtained from a single mold cavity. As illustrated in FIGS. 37-39A, a rack mold is illustrated for accommodating incremental inserts for forming different rack lengths from a single universal mold. As illustrated in FIG. 37, a mold cavity 500 is provided between a first mold plate 502 and second mold plate 504 one of which is movable relative to the other. The first mold plate 502 includes an elongated raised section 506 having teeth-like formations 508, 510 formed along opposite edges thereof. The second plate 504 includes a recess cavity 512 which combines with the raised portion 506 to define a mold cavity having a shape of the dual rack illustrated in FIGS. 32 and 33, as discussed above. As illustrated in FIGS. 38 and 39, at one end of the first plate 502, removable toothed mold sections 514, 516 are illustrated. The toothed sections 514, 516 can be removed and replaced with solid portions such as members 518, 520 which are provided as incremental inserts that allow different rack lengths to be obtained using the single universal mold 502, 504, as would be understood by one having ordinary skill in the art.

The value of using the combined solutions to provide for a universal dual rack and pinion power window regulator is substantial. Typically, car models average sales of 175 thousand units per year with the range varying from 50 thousand to 350 thousand. Table 1 below illustrates the influence of using these novel concepts on regulator amortization rates for an example case. For convenience, and in line with actual practice, a typical car model life is assumed to be seven years. Taking the average of 175 thousand sale units per year for a four-door vehicle; i.e., 750 thousand regulators total per year, then if a rack model is built to accommodate front and rear windows in the same vehicle, then just one more vehicle model at the same average annual volume will fully utilize a dual cavity rack mold. Therefore, in real life, molds would be carefully selected and mixed and matched to car models that are relatively close to one another in terms of the critical parameters of pillar angle, radius of curvature, and travel length. In summary then, by adopting and combining the solutions to the design elements of B-pillar angle, radii of curvature and length of travel to provide for a universal power window regulator, substantial savings occur in design time, capitalization costs, inventory, amortization costs, manufacturing convenience, and most importantly the improved overall simplicity of the total system.

The estimated capital expenditures and associated amortization costs for case A example, assuming two four-door vehicles with average yearly volumes of 175 thousand automobiles, seven year model lines, mold set cost for the front units, $260 thousand, mold set cost for the rear units $260 thousand, assembly line cost $300 thousand with yearly mold set, and assembly line capacity of 1.5 million units.

TABLE 1

| | Dedicated Molds | | | Universal Molds | | | |
|---|---|---|---|---|---|---|---|
| | | Assembly | | | Assembly | | Total |
| | Molds | Line | Total | Molds | Line | Total | Savings |
| Capital Cost | 1,040,000 | 300,000 | 1,340,000 | 260,000 | 300,000 | 560,000 | 780,000 |
| ($) | | | | | | | |
| Amortization | 10.6 | 3.0 | 13.6 | 2.7 | 3.0 | 5.7 | 7.9 |
| (¢ per unit) | | | | | | | |

From the above table, it is seen that the amortization cost is approximately 13.6 cents per unit utilizing dedicated molds, while the amortization cost is approximately 5.7 cents per unit for window regulators utilizing universal molds so that a total difference is obtained of approximately 7.9 cents per unit. Furthermore, the total up front investment is reduced by $780 thousand.

Estimated capital expenditures and associated amortization costs for case B example, assuming three four-door vehicles with average yearly volumes of 50 thousand, 100 thousand, and 200 thousand units, respectively. The Case B also assumes seven year model lines with mold set cost for the front units being $260 thousand, rear units being $260 thousand, and assembly line cost of $300 thousand with the yearly mold set and assembly line capacity of 1.5 million units, the same as in Case A.

TABLE 2

| | Dedicated Molds | | | Universal Molds | | | |
|---|---|---|---|---|---|---|---|
| | | Assembly | | | Assembly | | Total |
| | Molds | Line | Total | Molds | Line | Total | Savings |
| Capital Cost | 1,560,000 | 300,000 | 1,860,000 | 264,000 | 300,000 | 564,000 | 1,300,000 |
| ($) | | | | | | | |
| Amortization | 14.4 | 3.0 | 17.4 | 2.7 | 3.0 | 5.7 | 11.7 |
| (¢ per unit) | | | | | | | |

From the results illustrated in Table 2, the amortization cost using dedicated molds is 17.4 cents per unit while the amortization cost for using universal mold is 5.7 cents per unit providing a total savings of 11.7 cents per unit. Furthermore, the total up front capital investment is reduced by $1.3 million.

Another aspect of the present application centers around further entrancement of the greaseless nature of dual rack or pinion power window regulators. Old fashioned arm and sector and cable driver systems have numerous exposed components, both metal and plastic, which need to be greased to assist various sliding motors and to ensure quiet operation. The application of grease, either manually and/or automatically, to those components is costly and time consuming. Additionally, it generates a host of unwanted behaviors, namely:

(a) wearing away of grease over time which causes poorer, noisy performance as time progresses;

(b) non-equivalent performance at varying temperatures resulting in varying window travel time as temperature varies from ambient, to +180° F., and to −40° F. At −40, the grease tends to solidify and not function as a lubricant, while at high temperature, the grease becomes free-flowing and falls through gravity to the lowest areas, finally dripping off the units;

(c) grease has a tendency to absorb dust and crud so that after time it does not function as a lubricant but rather, as an abrasive causing excessive wear and, hence, looseness at critical locations;

(d) grease parts are difficult to handle during installation, requiring gloves and have the potential of increased dropped parts and surrounding body surface contamination.

The dual rack and pinion regulators discussed here, and as previously exemplified in the referenced patents, eliminate the unwanted behavior associated with old fashioned regulators by judiciously using an internally lubricated thermoplastic for the various component parts. From a lubrication vantage point, these parts function perfectly but have the unwanted behavior associated with all plastic components, namely, they inherently have the tendency to statically charge locally due to sliding or rubbing surface motion. These statically charged surfaces have a profound tendency to attract dust which potentially can cause surface pitting and, hence, less than optimal behavior as time progresses. This tendency to locally statically charge and remain charged may be readily eliminated by molding the various plastic components from a statically dissipative internally lubricated thermoplastic. To be statically dissipative, a molded surface resistivity must be less than 10−⁷ ohm/cm² and preferably less than 10−⁵ ohm/cm². This static dissipative character may be judiciously built-in to the base thermoplastic into a composite by the addition of various additives, namely, carbon black, graphite, metal powders, metal flakes, conductive polymers, and compounds and/or a combination of the above with selected fillers like mica, etc. Improved cost/performance may be achieved by matching the internal lubricant with a static dissipative additive which also has lubrication character; e.g., dispersive carbon black and/or graphite.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A bracket for a window lift mechanism, comprising:
a crossbar and transmission housing formed as a single unit, said crossbar and transmission housing including a motor mounting structure, a passage for receiving a drive shaft, a gear cavity, at least one rack guide feature and a slave gear hub portion all formed as a unitary piece.

2. The bracket according to claim 1, wherein said gear cavity includes a gear hub portion disposed therein.

3. The bracket according to claim 1, further comprising a pair of window bracket mounting features.

4. A bracket for a window lift mechanism, comprising:
a crossbar and transmission housing formed as a single unit, said crossbar and transmission housing including a passage for receiving a drive shaft, a gear cavity, at least one rack guide feature and a slave gear hub portion all formed as a unitary piece.

5. A bracket for a window lift mechanism, comprising:
a crossbar and transmission housing formed as a single unit, said crossbar and transmission housing including a motor mounting structure, a passage for receiving a drive shaft, at least one rack guide feature and a slave gear hub portion all formed as a unitary piece.

6. A bracket for a window lift mechanism, comprising:
a crossbar and transmission housing formed as a single unit, said crossbar and transmission housing including a motor mounting structure, a passage for receiving a drive shaft, a gear cavity and a slave gear hub portion all formed as a unitary piece.

7. A bracket for a window lift mechanism, comprising:
a crossbar and transmission housing formed as a single unit, said crossbar and transmission housing including a motor mounting structure, a passage for receiving a drive shaft, a gear cavity and at least one rack guide feature all formed as a unitary piece.

8. A bracket for a window lift mechanism, comprising:
a crossbar and transmission housing formed as a single unit, said crossbar and transmission housing including a motor mounting structure, a gear cavity, at least one rack guide feature and a slave gear hub portion all formed as a unitary piece.

9. A window lift mechanism, comprising:
a crossbar and transmission housing formed as a single unit, said crossbar and transmission housing including a motor mounting structure, a passage for receiving a drive shaft, at least one rack guide feature and a slave gear hub portion all formed as a unitary piece;
a motor mounted to said motor mounting structure, said motor including a drive shaft received in said passage;
a first pinion gear received operably driven by said motor;
a second pinion gear rotatably mounted to said slave gear hub and drivingly engaged with said first pinion gear; and
a dual rack system having parallel toothed racks spaced from one another and each engaging a respective one of said first and second pinion gears, said dual rack system being engaged by said at least one rack guide feature.

10. The window lift mechanism according to claim 9, wherein said crossbar and transmission housing includes a gear cavity, and further comprising a worm gear disposed in said gear cavity and drivably engaged with a worm mounted to said drive shaft, said worm gear being drivably engaged with said first pinion gear.

11. A window lift mechanism, comprising:
a crossbar and transmission housing formed as a single unit, said crossbar and transmission housing including a motor mounting structure, a passage for receiving a drive shaft, at least one rack guide feature and a gear cavity all formed as a unitary piece;
a motor mounted to said motor mounting structure, said motor including a drive shaft received in said passage;
a first pinion gear received operably driven by said motor;
a second pinion gear rotatably mounted to said crossbar and transmission housing; and
a dual rack system having parallel toothed racks spaced from one another and each engaging a respective one of said first and second pinion gears, said dual rack system being engaged by said at least one rack guide feature.

12. A method for assembling a window lift mechanism, comprising the steps of:
mounting a motor to a motor mounting feature of a crossbar and transmission housing, said crossbar and transmission housing including said motor mounting feature, a gear cavity, a passage for receiving a drive shaft, at least one rack guide feature and a slave gear hub portion all formed as a unitary piece;
said motor drivingly connected to a worm;
mounting a worm gear in said gear cavity;
mounting a first pinion gear in driving engagement with said worm gear and mounting a second pinion gear on said slave gear hub portion and in meshing engagement with said first pinion gear;
placing a dual rack system in alignment with said pinion gears; and
applying power to the motor to drive said pinion gears to engage said first and second pinion gears and said at least one rack guide feature with said dual rack system.

13. A method for assembling a window lift mechanism, comprising the steps of:
mounting a motor to a motor mounting feature of a crossbar and transmission housing, said crossbar and transmission housing including said motor mounting feature, a gear cavity, a passage for receiving a drive shaft and at least one rack guide feature all formed as a unitary piece;
said motor drivingly connected to a worm;
mounting a worm gear in said gear cavity in meshing engagement with said worm;
mounting a first pinion gear in driving engagement with said worm gear and mounting a second pinion gear on said crossbar and transmission housing;
placing a dual rack system in alignment with said pinion gears; and
applying power to the motor to drive said pinion gears to engage said first and second pinion gears and said at least one rack guide feature with said dual rack system.

14. A vehicle door comprising:
an outer door panel;
an inner door panel connected to said outer door panel;
a window lift mechanism disposed between said inner and outer door panels and including a pair of spaced racks and a support bracket supporting a pair of pinions in engagement with said pair of spaced racks;
a window mounted to said support bracket, said window including a top edge, a front edge, a rear edge and a bottom edge, one of said front and rear edges being angled so as to generally correspond with a first pillar angle, the other of said front and rear edges being angled so as to generally correspond to a second pillar angle, said first pillar angle being greater than zero degrees from vertical and said bottom edge being generally perpendicular to said one of said front and rear edge, and said pair of spaced racks being generally parallel to said first pillar angle.

15. A method of making dual racks for window lift mechanisms to be used with first and second vehicle doors having different window configurations, comprising:
determining a first radius of curvature for a first window of the first vehicle door;
determining a second radius of curvature for a second window of the second vehicle door;
determining a first required length of travel of said first window;
determining a second required length of travel of said second window;
providing a mold cavity defining a pair of parallel racks each having a plurality of gear teeth, a radius of curvature of said pair of parallel racks being between said first and second radii of curvature of the first and second windows and a length of said racks being sufficient to accommodate a longer of said first and second required lengths of travel of said first and second windows;
injecting molten plastic into said mold cavity; and
removing the molded racks from the mold cavity.

16. The method of claim 15, wherein during molding of the dual racks for the window having a shorter of said first and second required lengths of travel, an insert is provide in said mold cavity to shorten the length of gear teeth on said dual racks.

17. A vehicle door comprising:
an outer door panel;
an inner door panel connected to said outer door panel;
a window lift mechanism disposed between said inner and outer door panels and including a pair of parallel spaced toothed racks and a support bracket supporting a pair of pinions in driving engagement with said pair of spaced racks;
a window mounted to said support bracket, said window including a top edge, a front edge, a rear edge and a bottom edge, one of said front and rear edges being angled so as to generally correspond with a first pillar angle, said first pillar angle being greater than zero degrees from vertical and said bottom edge being generally horizontal, wherein said pair of racks are mounted generally parallel to said first pillar angle and said window is mounted to said support bracket via a pair of mount brackets, one of said mount brackets being longer than the other to accommodate for said first pillar angle.

18. A window lift mechanism, comprising:
a support bracket;
a drive motor supported on said support bracket;
a first pinion rotatably driven by said drive motor, said first pinion engaging a first rack;
a second pinion rotatably driven by said first pinion, said second pinion engaging a second rack, whereby rotation of said motor causes movement of said support bracket relative to said first and second racks, wherein at least one of said support bracket and said first and second racks is made from a statically dissipative plastic composite material.

19. The window lift mechanism according to claim 18, wherein said first and second pinions are made from a statically dissipative plastic composite material.
